(19) United States
(12) Patent Application Publication
(10) Pub. No.: US 2013/0142198 A1
(43) Pub. Date: Jun. 6, 2013

(54) TRANSMISSION DEVICE AND INTERFACE DEVICE

(71) Applicant: HITACHI, LTD., Tokyo (JP)

(72) Inventor: Toshiyuki ATSUMI, Fujisawa (JP)

(73) Assignee: HITACHI, LTD., Tokyo (JP)

(21) Appl. No.: 13/682,094

(22) Filed: Nov. 20, 2012

(30) Foreign Application Priority Data
Dec. 1, 2011 (JP) 2011-263830

(51) Int. Cl. H04L 12/56

(52) U.S. Cl. CPC H04L 49/00
USPC 370/389

(57) ABSTRACT

A transmission device for receiving a user signal and transmitting to another device a transmission signal, the transmission device comprising: a plurality of interface units each capable of accommodating a communication line; and a cross-connect unit for branching the user signal and coupling the communication line accommodated by each of the plurality of interface units to a client device, wherein the transmission device is configured to provide redundancy to the communication line by using the plurality of interface units, wherein the each of the plurality of interface units having a switching control module for performing switching control of an interface unit that accommodates a communication line for transmitting a main signal to the client device.

### CLAIM OF PRIORITY

The present application claims priority from Japanese patent application JP 2011-263830 filed on Dec. 1, 2011, the content of which is hereby incorporated by reference into this application.

### BACKGROUND OF THE INVENTION

This invention relates to a transmission device and an interface device for realizing switching control in packet transport such as the MPLS-TP.

In recent years, broadband lines represented by the Internet have spread into houses, which results in an increased need for the lines mainly by IP traffics and a rapid increase in various services provisioned therein.

Under such circumstances, as a cross-connect method in a layer 1 transmission device, the mainstream has shifted from the conventional “line switching” represented by the SDH to “packet switching” having high affinity to IP networks represented by routers.

A representative cross-connect method of the packet switching is Multi Protocol Label Switch (MPLS) (see, for example, IETF RFC 3031 “Multiprotocol Label Switching Architecture”). In the MPLS, generally, a route is determined by a predetermined algorithm, and information is exchanged between nodes coupled via the determined route to determine a label. Each node holds, as route information, a table showing correspondence between an input label and an output port, and transfers data to the output port specified based on the table.

In a packet transmission network represented by the MPLS, the concept of “path”, which is a physical transfer path in the SDH, does not exist. As a method of managing the route, a distributed management method involving determining a transfer destination for each node based on a predetermined policy such as the resources of the network and the number of hops is used as a basic method.

In the packet transmission network described above, data is transmitted on a packet-by-packet basis without securing a fixed time slot, and hence there is an advantage in that the traffic may be accommodated efficiently. However, each device determines the route autonomously based on a route selection algorithm, and hence an explicit route is not known. Further, when a failure occurs, a failure point and an affected range are difficult to identify, which is a big problem in maintainability and in terms of management.

In order to overcome the above-mentioned problem in maintainability and in terms of management, standardization of a technology called Multi Protocol Label Switch Transport Profile (MPLS-TP) is currently underway in the IETF (see, for example, IETF RFC 5654 “Requirements of an MPLS Transport Profile”).

The MPLS-TP is a technology which adopts the transmission method of transmitting packets in the MPLS and which combines the reliability and high operability in terms of maintenance and operation in the conventional legacy line such as the SDH. Therefore, in the MPLS-TP, characteristic functions (ideas) of “expanding the operation, administration, and maintenance (OAM) function”, “explicit route management”, and “separation of the control plane and the data plane” are introduced to the conventional MPLS.

The “OAM function” is a collective name of various maintenance and operation functions for supporting stable data transfer at high quality, and is constituted of “failure detecting function”, “failure point identifying function”, “failure notifying function”, “performance monitoring function”, and “protecting function”. In order to realize the above-mentioned functions, separately from the packet for transferring the service, normalization of the packet dedicated to the OAM is underway (see, for example, IETF RFC 5860 “Requirements for Operations, Administration, and Maintenance (OAM) in MPLS Transport Networks”).

The “explicit route managing function” allows, as opposed to autonomic distributed route determination method which has been a mainstream in the conventional packet transmission network, a person in charge of maintenance to specify a start point, an end point, and a via point as the route through which the traffic passes, to thereby set the route statically. The route which is specified once is not updated automatically by factors other than a setting instruction from the person in charge of maintenance. This allows the person in charge of maintenance to clearly know where the service line is actually transmitted through.

The “separation of the control plane and the data plane” means that the functional module for controlling the modules in the node and the functional module for transferring data are separated, which is an idea for preventing, even when a failure occurs in the functional module for controlling the modules in the node, for example, the functional module for transferring data from being affected.

The MPLS-TP follows a transmission method similar to the MPLS as described above. Therefore, the MPLS-TP has features of allowing multiprotocol accommodating, which accommodates user signals irrespective of the types of the accommodated signals by using the MPLS label, and of being capable of separating clear service classes among the user signals by using QoS control.

The MPLS-TP is a growing technical field as a technology of combining the above-mentioned technology and the line emulation technology to accommodate the rapidly increasing IP traffics and the conventional SDH line such as the SDH in the same platform and to manage a layer 1 network and a layer 2 network in combination.

Related art documents relating to the switching control method of the transmission device include, for example, Japanese Patent Application Laid-open Nos. 2004-207849, 06-311131, and 2001-160793.

### SUMMARY OF THE INVENTION

Those characteristic functions and ideas of the MPLS-TP, that is, “expanding the operation, administration, and maintenance (OAM) function”, “explicit route management”, and “separation of the control plane and the data plane” are necessitated as a result of pursuing high maintainability, reliability, and fault tolerance of the MPLS-TP. Among others, the separation of the control plane for monitoring and controlling the line and the data plane for transmitting and receiving the user signals is an important function in terms of the maintainability and the fault tolerance.

The conventional transmission device generally includes, as described in Japanese Patent Application Laid-open Nos. 2004-207849 and 06-311131, an interface unit for executing main signal processing such as signal termination processing, and a monitoring and control module for monitoring and controlling the device.

The transmission device has a configuration in which, in order to increase the reliability and the fault tolerance of a main signal transfer path, the main signal transfer path is duplicated as a first route and a second route. When a failure occurs in the first route, the transmission device executes a failure relief processing by switching to the second route so that a disconnected state of a main signal to be transferred between a device as a transfer destination of the main signal and the transmission device does not continue. The route switching control described above is another function of the monitoring and control module.

In the conventional transmission device, in order to increase the fault tolerance of the main signal, an interface card for accommodating the first route and an interface card for accommodating the second route are different cards. Further, the conventional transmission device needs to have a configuration capable of monitoring the interface cards, and hence the monitoring and control module for performing switching control between the interface cards and executing processing of transmitting switching information to an opposing device is mounted in a card different from the interface cards.

However, the above-mentioned monitoring and control module may temporarily become out of service during a series of maintenance operations, such as a file update operation of software for realizing the monitoring and control module, and in a case where the person in charge of maintenance resets the monitoring and control module intentionally. Therefore, there has been a problem in that, during the temporal out-of-service period, the transmission device cannot switch the transmission path, and hence in case where a failure that affects the main signal occurs, the main signal remains in a blocked state and is not relieved.

There is also known means for continuing, in a case where the monitoring and control module is reset during the switching control and the switching information is initialized, the switching control immediately after the initialization without any contradiction from the state before the resetting (see, for example, Japanese Patent Application Laid-open No. 2001-160793).

However, with the means described in Japanese Patent Application Laid-open No. 2001-160793, the switching control stops from the reset to the restart of the monitoring and control module. Therefore, means for ensuring the switching control from the reset to the restart of the monitoring and control module is not provided.

On the other hand, there may be contemplated a method involving duplicating the monitoring and control module per se so that, even if one monitoring and control module enters the out-of-service state, the other monitoring and control module continues the switching control, to thereby improve the reliability of the switching control.

However, in a configuration in which many lines are accommodated under the monitoring and control module, in a case where line failures occur simultaneously and many main signals are to be switched at once, it takes time from the occurrence of the line failure to the completion of the switching control, the time corresponding to the number of provisioned main signals.

For example, there is a problem in that the time may exceed 50 ms, which is specified for the switching time of the legacy line such as the SDH, and even when the monitoring and control module is duplicated, a restriction is imposed on the scalability of the number of interface cards and the number of accommodated lines. Even when the switching time does not exceed 50 ms, the time required until the completion of the switching processing is lengthened proportionally to the number of accommodated lines.

The present invention can be appreciated by the description which follows in conjunction with the following figures, wherein: a transmission device for receiving a user signal and transmitting to another device a transmission signal obtained by reflecting an APS transmission value on the received user signal. The transmission device comprises: a plurality of interface units each capable of accommodating a communication line; and a cross-connect unit for branching the user signal, which is transmitted from a client device, to be transmitted to each of the plurality of interface units, and coupling the communication line accommodated by each of the plurality of interface units to the client device. The transmission device is configured to provide redundancy to the communication line by using the plurality of interface units. The each of the plurality of interface units has a switching control module for performing switching control of an interface unit that accommodates a communication line for transmitting a main signal to the client device. The switching control module is configured to: select the interface unit for transmitting the main signal from among the plurality of interface units providing the redundancy; and switch to any one of the plurality of interface units providing the redundancy to continue the transmission of the main signal, in a case where a failure occurs in the selected interface unit.

With each interface card including the switching control module for performing switching control of the communication line through which the main signal is transmitted, the single point of failure due to the failure of the switching control module may be avoided. In addition, the failure of the switching control module may be addressed quickly. Further, necessary processing is executed as processing in the interface card, and hence the switching of the communication line may be performed at high speed.

### BRIEF DESCRIPTION OF THE DRAWINGS

The present invention can be appreciated by the description which follows in conjunction with the following figures, wherein:

FIG. 1 is a block diagram illustrating a configuration example of a transmission device according to the embodiment of this invention;

FIGS. 2A and 2B are block diagrams illustrating detailed configurations of a system 0 interface car, a system 1 interface card, and a cross-connect card according to the embodiment of this invention;

FIG. 3 is an explanatory diagram illustrating a concept of a transition table according to the embodiment of this invention;

FIG. 4 is an explanatory diagram illustrating a specific example of the transition table according to the embodiment of this invention;

FIGS. 5A and 5B are explanatory diagrams illustrating a switching control of a line according to the embodiment of this invention;

FIGS. 6A and 6B are explanatory diagrams illustrating the switching control of a line according to the embodiment of this invention;

FIGS. 7 and 8 are sequence diagrams illustrating a flow of the processing of switching between a master and slave according to the embodiment of this invention; and

FIG. 9 is an explanatory diagram illustrating the conventional transmission device.

### DETAILED DESCRIPTION OF THE PREFERRED EMBODIMENT

Hereinafter, an embodiment of this invention is described with reference to the accompanying drawings.

First, a configuration example of a conventional transmission device is described.

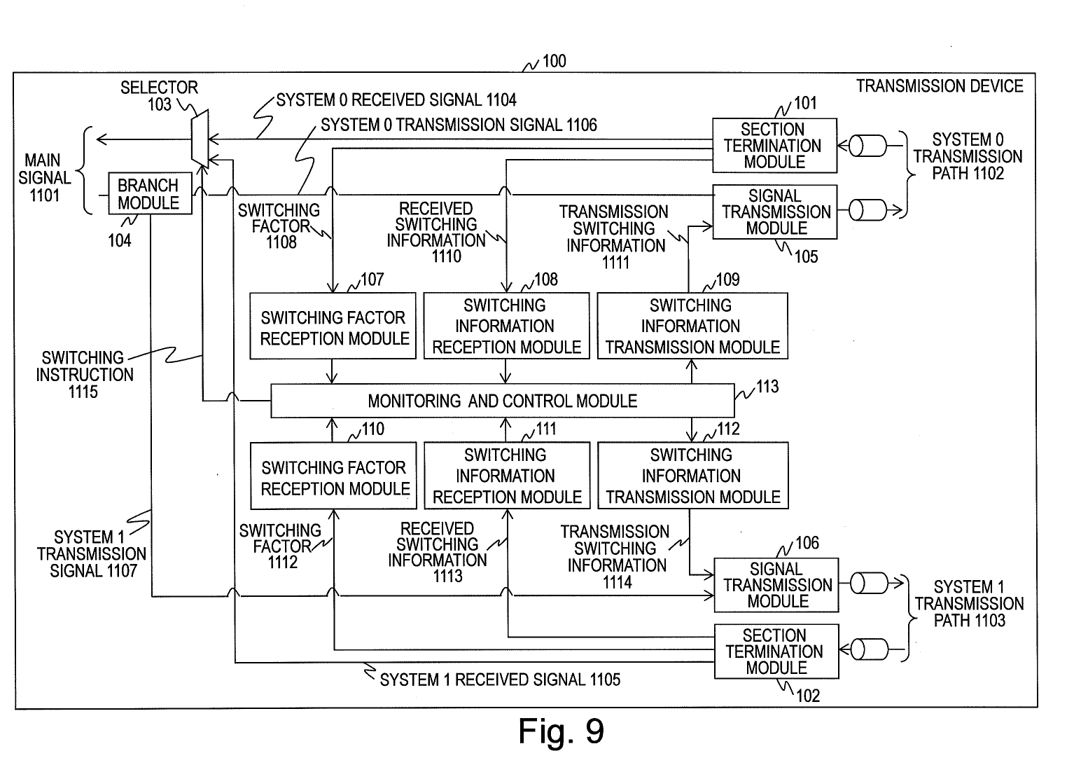

FIG. 9 is an explanatory diagram illustrating the conventional transmission device.

A conventional transmission device 100 includes a monitoring and control module 113, a section termination module 101, a signal transmission module 105, a switching factor reception module 107, a switching information reception module 108, a switching information transmission module 109, a section termination module 102, a signal transmission module 106, a switching factor reception module 110, a switching information reception module 111, a switching information transmission module 112, a selector 103, and a branch module 104.

The monitoring and control module 113 controls switching of a line (transmission path). The section termination module 101 receives signals from a system 0 transmission path 1102, and the signal transmission module 105 transmits signals to the system 0 transmission path 1102.

The switching factor reception module 107 receives a switching factor 1108 from the section termination module 101 and transfers the switching factor 1108 to the monitoring and control module 113. The switching information reception module 108 receives received switching information 1110 from the section termination module 101 and transfers the received switching information 1110 to the monitoring and control module 113. The switching information transmission module 109 receives transmission switching information 1111 from the monitoring and control module 113 and transfers the transmission switching information 1111 to the signal transmission module 105.

The section termination module 102 receives signals from a system 1 transmission path 1103, and the signal transmission module 106 transmits signals to the system 1 transmission path 1103.

The switching factor reception module 110 receives a switching factor 1112 from the section termination module 102 and transfers the switching factor 1112 to the monitoring and control module 113. The switching information reception module 111 receives received switching information 1113 from the section termination module 102 and transfers the received switching information 1113 to the monitoring and control module 113. The switching information transmission module 112 receives transmission switching information 1114 from the monitoring and control module 113 and transfers the transmission switching information 1114 to the signal transmission module 106.

The selector 103 selects one of a system 0 received signal 1104 and a system 1 received signal 1105 based on an instruction from the monitoring and control module 113. The branch module 104 branches a main signal 1101 into a system 0 transmission signal 1106 to be transmitted to the system 0 transmission path 1102 and a system 1 transmission signal 1107 to be transmitted to the system 1 transmission path 1103.

In other words, in a transmission direction (bottom to top direction of FIG. 9) of the transmission path, the branch module 104 branches the main signal 1101 into the system 0 transmission signal 1106 and the system 1 transmission signal 1107, and in a reception direction (top to bottom direction of FIG. 9) of the transmission path, the selector 103 selects one of the system 0 received signal 1104 and the system 1 received signal 1105. As a result, a configuration in which the transmission path is redundant is provided.

The monitoring and control module 113 receives the switching factor 1108 and the received switching information 1110 from the switching factor reception module 107 and the switching information reception module 108 on the system 0 side, respectively, and receives the switching factor 1112 and the received switching information 1113 from the switching factor reception module 110 and the switching information reception module 111 on the system 1 side, respectively.

The monitoring and control module 113 determines, based on the received information, which of the system 0 received signal 1104 and the system 1 received signal 1105 is to be set as the main signal, and transmits a switching instruction 1115 including the determination result to the selector 103. Further, in order to notify a coupling destination device of each of the system 0 transmission path 1102 and the system 1 transmission path 1103 of contents of the switching instruction 1115, the monitoring and control module 113 transmits the transmission switching information 1111 to the signal transmission module 105 of the system 0 or transmits the transmission switching information 1114 to the signal transmission module 106 of the system 1. The transmission switching information 1111 is transmitted to the coupling destination device via the system 0 transmission path 1102, and the transmission switching information 1114 is transmitted to the coupling destination device via the system 1 transmission path 1103.

The selector 103 selects one of the system 0 received signal 1104 and the system 1 received signal 1105 based on the switching instruction 1115 received from the monitoring and control module 113.

As described above, the transmission device 100 generates the switching instruction based on information such as the switching factor, and transmits its own switching information to the coupling destination device so that the switching information is exchanged from/to the coupling destination device to implement the line switching control.

The series of processing is performed by the monitoring and control module 113. Therefore, as illustrated in FIG. 9, with the configuration of the conventional transmission device 100, in a case where the monitoring and control module 113 is out of service, a state in which the line switching control cannot be performed occurs.

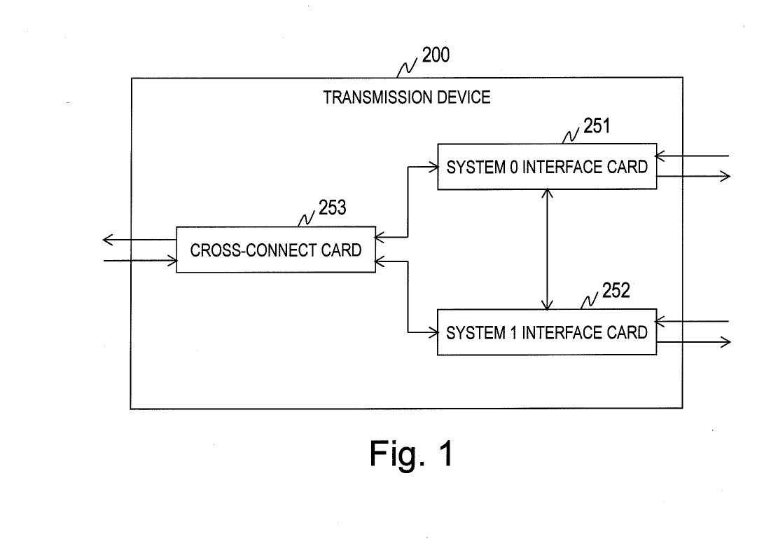

FIG. 1 is a block diagram illustrating a configuration example of a transmission device according to the embodiment of this invention.

As illustrated in FIG. 1, a transmission device 200 according to this embodiment includes a system 0 interface card 251, a system 1 interface card 252, and a cross-connect card 253.

The system 0 interface card 251 and the system 1 interface card 252 transmit signals received from an opposing device such as another transmission device to the cross-connect card 253, and the cross-connect card 253 transmits a main signal to a client device or the like.

The cross-connect card 253 also branches the main signal received from the client device or the like, and transmits the main signal branched to the system 0 interface card 251 and the system 1 interface card 252. Each of the system 0 interface card 251 and the system 1 interface card 252 transmits the received main signal to the opposing device.

In the example illustrated in FIG. 1, the transmission device 200 includes only two interface cards. However, this invention is not limited thereto, and the transmission device 200 may include three or more interface cards. The transmission device 200 may also include another component (not shown).

The system 0 interface card 251, the system 1 interface card 252, and the cross-connect card 253 are communicably connected to one another. Each of the system 0 interface card 251, the system 1 interface card 252, and the cross-connect card 253 includes at least one processor (not shown), at least one memory (not shown), and the like as hardware components.

Next, details of the system 0 interface card 251, the system 1 interface card 252, and the cross-connect card 253 are described.

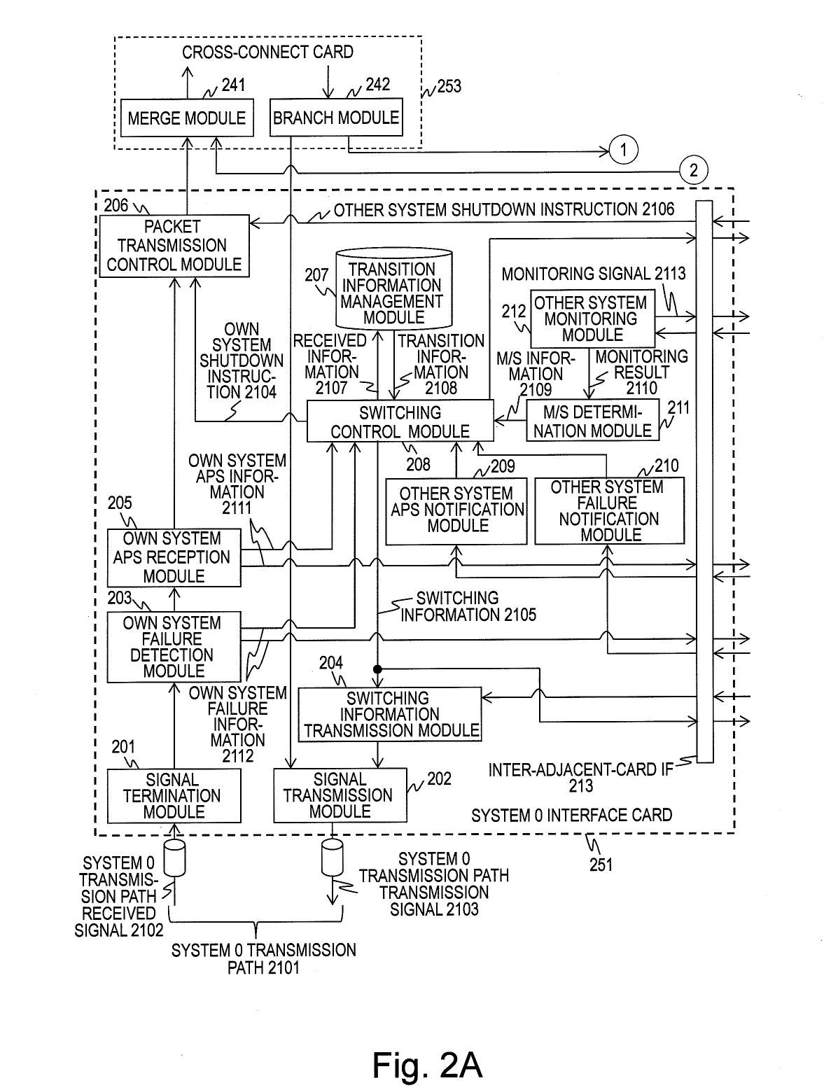

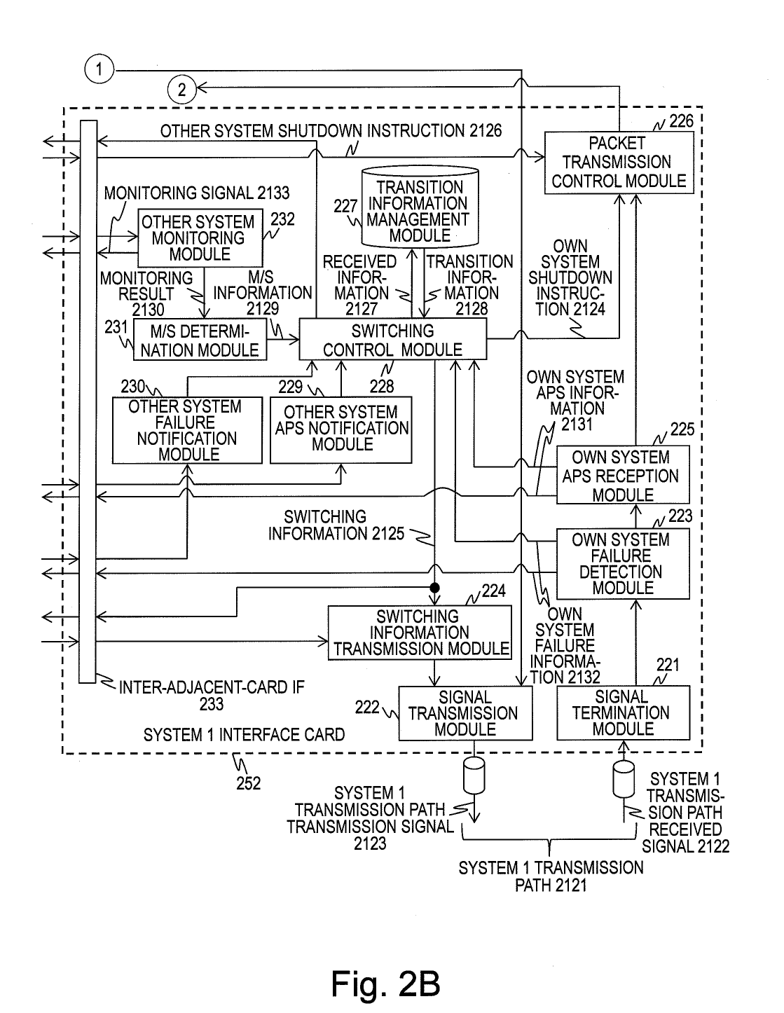

FIGS. 2A and 2B are block diagrams illustrating detailed configurations of the system 0 interface card 251, the system 1 interface card 252, and the cross-connect card 253 according to the embodiment of this invention.

As illustrated in FIGS. 2A and 2B, the system 0 interface card 251 accommodates a system 0 transmission path 2101 and the system 1 interface card 252 accommodates a system 1 transmission path 2121 so that the line is made redundant by the system 0 transmission path 2101 and the system 1 transmission path 2121.

It should be noted that, in a case where the transmission device 200 includes three or more interface cards, the line may be made redundant by the three or more interface cards.

The system 0 interface card 251 includes a signal termination module 201, an own system failure detection module 203, an own system APS reception module 205, a packet transmission control module 206, a switching information transmission module 204, a signal transmission module 202, an other system failure notification module 210, an other system APS notification module 209, a switching control module 208, a transition information management module 207, an other system monitoring module 212, an M/S determination module 211, and an inter-adjacent-card IF 213.

The signal termination module 201 executes termination processing on a system 0 transmission path received signal 2102.

The own system failure detection module 203 detects a failure state of the system 0 interface card 251. The own system failure detection module 203 also transmits own system failure information 2112 including the detected failure state to the switching control module 208 and the inter-adjacent-card IF 213. The own system APS reception module 205 extracts a received APS byte from the system 0 transmission path received signal 2102. The own system APS reception module 205 also transmits own system APS information 2111 including the extracted received APS byte to the switching control module 208 and the inter-adjacent-card IF 213.

The packet transmission control module 206 performs transmission control and stop control on a packet signal from the system 0 interface card 251 to the cross-connect card 253.

The switching information transmission module 204 reflects switching information 2105 including a switching state of the system 0 interface card 251 itself on the APS byte. The signal transmission module 202 generates a system 0 transmission path transmission signal 2103 by multiplexing the main signal received from the cross-connect card 253 with the APS byte received from the switching information transmission module 204.

The other system failure notification module 210 receives, from the system 1 interface card 252, failure information (own system failure information 2132) of a system 1 transmission path received signal 2122 received by the system 1 interface card 252. The other system APS notification module 209 receives, from the system 1 interface card 252, APS information (own system APS information 2131) of the system 1 transmission path received signal 2122 received by the system 1 interface card 252.

The switching control module 208 performs switching control of the transmission path (line) between the system 0 transmission path 2101 and the system 1 transmission path 2121. Specifically, in the switching control, which of the system 0 transmission path received signal 2102 and the system 1 transmission path received signal 2122 is to be transmitted as the main signal from the cross-connect card 253 is determined. In this embodiment, the switching control module 208 switches the transmission path by transmitting an own system shutdown instruction 2104 to the packet transmission control module 206 or transmitting an other system shutdown instruction 2126 to a packet transmission control module 226.

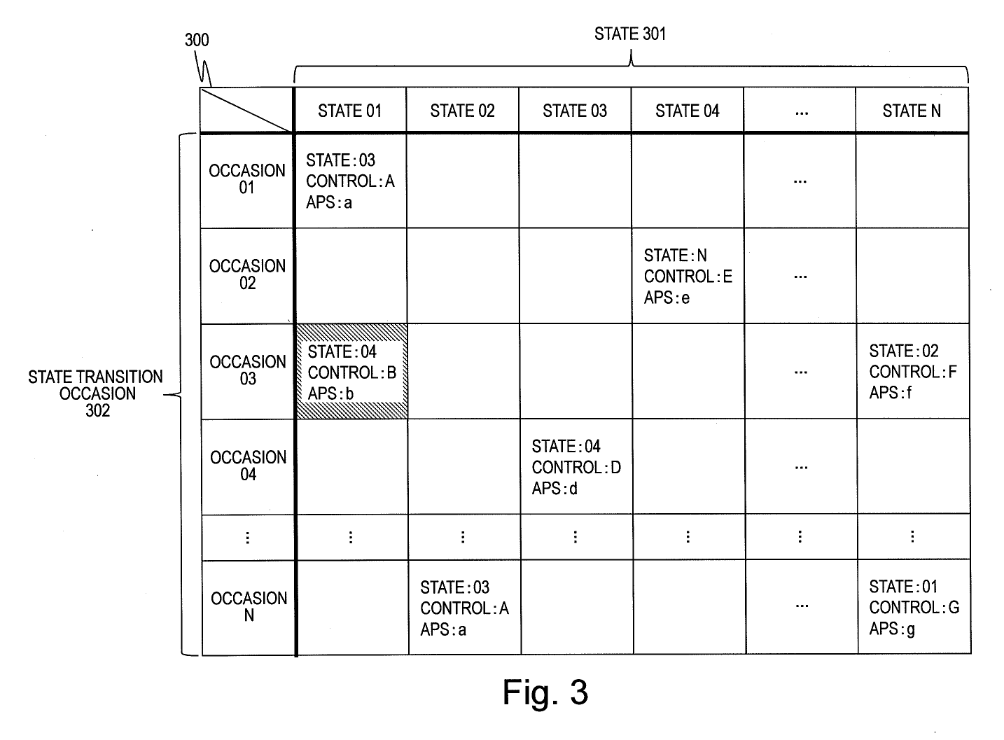

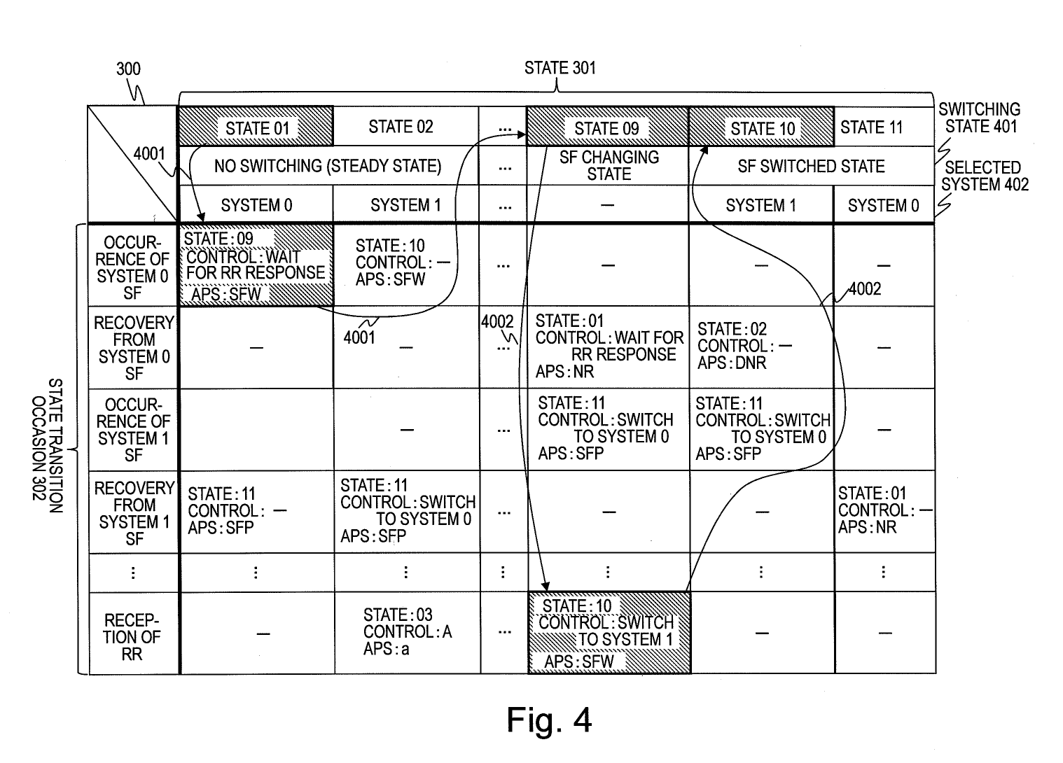

The transition information management module 207 holds a transition table 300 (see FIGS. 3 and 4), and refers to the transition table 300 (see FIGS. 3 and 4) based on the received failure information and the received APS information to read information necessary for the switching control. Further, the transition information management module 207 notifies the switching control module 208 of the read information. It should be noted that details of the transition table 300 are described below with reference to FIGS. 3 and 4.

The other system monitoring module 212 checks an operating state of a switching control module 228 of the system 1 interface card 252, which is the other system. Specifically, the other system monitoring module 212 checks the operating state of the switching control module 228 by transmitting a monitoring signal 2113 to an other system monitoring module 232. The other system monitoring module 212 also transmits a monitoring result 2110 to the M/S determination module 211.

The M/S determination module 211 determines, based on the monitoring result of the other system monitoring module 212, which of the switching control module 208 of the system 0 interface card 251 and the switching control module 228 of the system 1 interface card 252 serves as a master. The M/S determination module 211 also transmits M/S information 2109 including the determination result to the switching control module 208.

It should be noted that in this embodiment, the switching control module 208 or the switching control module 228 serving as the master performs the switching control initiatively. This indicates that the switching control module 208 or the switching control module 228 serving as the master is a switching control module of an active system. On the other hand, the switching control module 208 or the switching control module 228 not serving as the master serves as a slave (standby system).

The inter-adjacent-card IF 213 is an interface for transmitting and receiving various kinds of information to/from the system 1 interface card 252.

The system 1 interface card 252 includes, similarly to the system 0 interface card 251, a signal termination module 221, an own system failure detection module 223, an own system APS reception module 225, the packet transmission control module 226, a switching information transmission module 224, a signal transmission module 222, an other system failure notification module 230, an other system APS notification module 229, the switching control module 228, a transition information management module 227, the other system monitoring module 232, an M/S determination module 231, and an inter-adjacent-card IF 233.

The signal termination module 221 executes termination processing on the system 1 transmission path received signal 2122. The own system failure detection module 223 detects a failure state of the system 1 interface card 252. The own system failure detection module 223 also transmits the own system failure information 2132 including the detected failure state to the switching control module 228 and the inter-adjacent-card IF 233. The own system APS reception module 225 extracts a received APS byte from the system 1 transmission path received signal 2122. The own system APS reception module 225 also transmits the own system APS information 2131 including the extracted received APS byte to the switching control module 228 and the inter-adjacent-card IF 233.

The packet transmission control module 226 performs transmission control and stop control on a packet signal from the system 1 interface card 252 to the cross-connect card 253.

The switching information transmission module 224 reflects switching information 2125 including a switching state of the system 1 interface card 252 itself on the APS byte. The signal transmission module 222 generates a system 1 transmission path transmission signal 2123 by multiplexing the main signal received from the cross-connect card 253 with the APS byte received from the switching information transmission module 224.

The other system failure notification module 230 receives, from the system 0 interface card 251, failure information (the own system failure information 2112) of the system 0 transmission path received signal 2102 received by the system 0 interface card 251. The other system APS notification module 229 receives, from the system 0 interface card 251, APS information (the own system APS information 2111) of the system 0 transmission path received signal 2102 received by the system 0 interface card 251.

The switching control module 228 performs switching control of the transmission path (line) between the system 0 transmission path 2101 and the system 1 transmission path 2121. Specifically, in the switching control, which of the system 0 transmission path received signal 2102 and the system 1 transmission path received signal 2122 is to be transmitted as the main signal from the cross-connect card 253 is determined. In this embodiment, the switching control module 228 switches the transmission path by transmitting an own system shutdown instruction 2124 to the packet transmission control module 226 or transmitting an other system shutdown instruction 2106 to the packet transmission control module 206.

The transition information management module 227 holds the transition table 300 (see FIGS. 3 and 4), and refers to the transition table 300 (see FIGS. 3 and 4) based on the received failure information and the received APS information to read information necessary for the switching control. Further, the transition information management module 227 notifies the switching control module 228 of the read information. It should be noted that details of the transition table 300 are described below with reference to FIGS. 3 and 4.

The other system monitoring module 232 checks an operating state of the switching control module 208 of the system 0 interface card 251, which is the other system. Specifically, the other system monitoring module 232 checks the operating state of the switching control module 208 by transmitting a monitoring signal 2133 to an other system monitoring module 212. The other system monitoring module 232 also transmits a monitoring result 2130 to the M/S determination module 231.

The M/S determination module 231 determines, based on the monitoring result of the other system monitoring module 232, which of the switching control module 208 of the system 0 interface card 251 and the switching control module 228 of the system 1 interface card 252 serves as a master. The M/S determination module 231 also transmits M/S information 2129 including the determination result to the switching control module 228. In this embodiment, the switching control module 208 or the switching control module 228 serving as the master performs the switching control initiatively.

The inter-adjacent-card IF 233 is an interface for transmitting and receiving various kinds of information detected by the system 0 interface card 251.

The system 0 interface card 251 and the system 1 interface card 252 according to this embodiment include the switching control module 208 and the switching control module 228 for performing the line switching control, respectively. It should be noted, however, that in a case where the switching control module 208 and the switching control module 228 operate simultaneously, inconsistency arises in the switching control, and hence the master for performing the switching control initiatively is set.

In this embodiment, constituent modules of the system 0 interface card 251 and the system 1 interface card 252 are implemented by using special hardware. For example, a special processor and a special memory may be provided separately from the processor and the memory used for transmitting and receiving the signals, and the special processor may execute programs stored in the specific memory to implement the constituent modules. This invention is not limited thereto, and alternatively the processor may execute programs stored in the memory to implement equivalent functions.

The system 0 interface card 251 and the system 1 interface card 252 are connected to each other by a plurality of signal lines via the inter-adjacent-card IF 213 and the inter-adjacent-card IF 233.

The first signal line is a signal line for notifying each other of the failure information.

Specifically, in the signal line, the own system failure information 2112 including the failure state detected by the own system failure detection module 203 is transmitted to the other system failure notification module 230 via the inter-adjacent-card IF 213 and the inter-adjacent-card IF 233. Further, the own system failure information 2112 is transmitted from the other system failure notification module 230 to the switching control module 228. Similarly, in the signal line, the own system failure information 2132 including failure information detected by the own system failure detection module 223 is transmitted to the other system failure notification module 210 via the inter-adjacent-card IF 233 and the inter-adjacent-card IF 213. Further, the own system failure information 2132 is transmitted from the other system failure notification module 210 to the switching control module 208.

The second signal line is a signal line for notifying each other of the APS information.

Specifically, in the signal line, the own system APS information 2111 including the received APS byte detected by the own system APS reception module 205 is transmitted to the other system APS notification module 229 via the inter-adjacent-card IF 213 and the inter-adjacent-card IF 233. Further, the own system APS information 2111 is transmitted from the other system APS notification module 229 to the switching control module 228. Similarly, in the signal line, the own system APS information 2131 including received APS byte detected by the own system APS reception module 225 is transmitted to the other system APS notification module 209 via the inter-adjacent-card IF 233 and the inter-adjacent-card IF 213. Further, the own system APS information 2131 is transmitted from the other system APS notification module 209 to the switching control module 208.

The third signal line is a signal line for notifying each other of the shutdown instruction.

Specifically, in the signal line, the other system shutdown instruction 2126 transmitted from the switching control module 208 is transmitted to the packet transmission control module 226 via the inter-adjacent-card IF 213 and the inter-adjacent-card IF 233. Similarly, in the signal line, the other system shutdown instruction 2106 transmitted from the switching control module 228 is transmitted to the packet transmission control module 206 via the inter-adjacent-card IF 233 and the inter-adjacent-card IF 213.

The fourth signal line is a signal line for transmitting monitoring signals of the switching control module 208 and the switching control module 228.

Specifically, in the signal line, the monitoring signal 2113 transmitted from the other system monitoring module 212 is transmitted to the other system monitoring module 232 via the inter-adjacent-card IF 213 and the inter-adjacent-card IF 233. Similarly, in the signal line, the monitoring signal 2133 transmitted from the other system monitoring module 232 is transmitted to the other system monitoring module 212 via the inter-adjacent-card IF 233 and the inter-adjacent-card IF 213.

The fifth signal line is a signal line for notifying each other of the switching information.

Specifically, in the signal line, the switching information 2105 transmitted from the switching control module 208 is transmitted to the switching information transmission module 224 via the inter-adjacent-card IF 213 and the inter-adjacent-card IF 233. Similarly, in the signal line, the switching information 2125 transmitted from the switching control module 228 is transmitted to the switching information transmission module 204 via the inter-adjacent-card IF 233 and the inter-adjacent-card IF 213.

The inter-adjacent-card IF 213 and the inter-adjacent-card IF 233 are connected to each other symmetrically via the above-mentioned five signal lines. In this embodiment, the system 0 interface card 251 and the system 1 interface card 252 are desirably connected by hardware without any intervening software. In other words, a configuration in which the above-mentioned pieces of information may be transferred by using hardware is desired.

This is because, in a case where the above-mentioned information and control signals are transferred by intervening software, when a failure occurs in the software running on one of the system 0 interface card 251 and the system 1 interface card 252, necessary information cannot be transmitted or received, with a result that the switching control cannot be performed.

Assuming the configuration as described above, the specific switching control according to this invention is described. It should be noted that in the following, a case where the switching control module 208 of the system 0 interface card 251 operates as the master and a case where the switching control module 228 of the system 1 interface card 252 operates as the master are described separately.

First, a configuration example of the transition table 300 held in each of the transition information management module 207 and the transition information management module 227 is described.

FIG. 3 is an explanatory diagram illustrating a concept of the transition table 300 according to the embodiment of this invention. FIG. 4 is an explanatory diagram illustrating a specific example of the transition table 300 according to the embodiment of this invention.

As illustrated in FIG. 3, the transition table 300 forms a matrix having a state 301 in the horizontal direction and a state transition occasion 302 in the vertical direction. Further, at intersecting portions of rows and columns, transition information necessary for the switching control is defined. Specifically, a “state”, “control”, and “APS” are defined as the transition information.

The state 301 indicates states of the switching control. In this embodiment, the content of the switching control is defined depending on the states. The state transition occasion 302 indicates occasions for state transition.

The “state” indicates a state to which the switching control transitions. The “control” indicates a specific content of the switching control. The “APS” indicates an APS transmission value to be reflected on the signal transmitted from a branch module 242.

For example, in the example illustrated in FIG. 3, in a state of “State 01”, in a case where “Occasion 03” arises, the switching control is performed based on the transition information defined in the intersecting portion (hatched portion) of State 01 and Occasion 03. In this case, the switching control module 208 or the switching control module 228 performs “control: B”, transmits “APS: b” as the APS transmission value, transitions to a state of “State 04”, and waits for the next occasion for state transition.

Each time an occasion corresponding to the state transition occasion 302 arises, the transition information management module 207 and the transition information management module 227 determine the transition information (state, control, and APS) corresponding to the occasion that has arisen.

The specific transition table 300 illustrated in FIG. 4 forms a matrix similarly to the transition table 300 illustrated in FIG. 3. It should be noted that the state 301 is defined by a combination of a switching state 401 and a selected system 402. As the state transition occasion 302, occurrence of system 0 SF, recovery from system 0 SF, occurrence of system 1 SF, recovery from system 1 SF, reception of RR, and the like are defined by all pieces of information detected by the own system APS reception module 205, the own system failure detection module 203, the own system APS reception module 225, and the own system failure detection module 223 in FIGS. 2A and 2B.

At intersecting portions of rows and columns, similarly to the transition table 300 illustrated in FIG. 3, the transition information including the “state”, “control”, and “APS” is defined.

In this embodiment, it is assumed that the transition table 300 is provided for each of protocols such as ITU-T G.841, ITU-T G.841 Annex B, ITU-T G.8031, and Telcordia GR-253-CORE.

Next, details of the switching control are described by taking the transition table 300 illustrated in FIG. 4 as an example.

(1) Case where the system 0 interface card 251 operates as the master, and a failure occurs in the system 0 transmission path 2101 as a accommodated line.

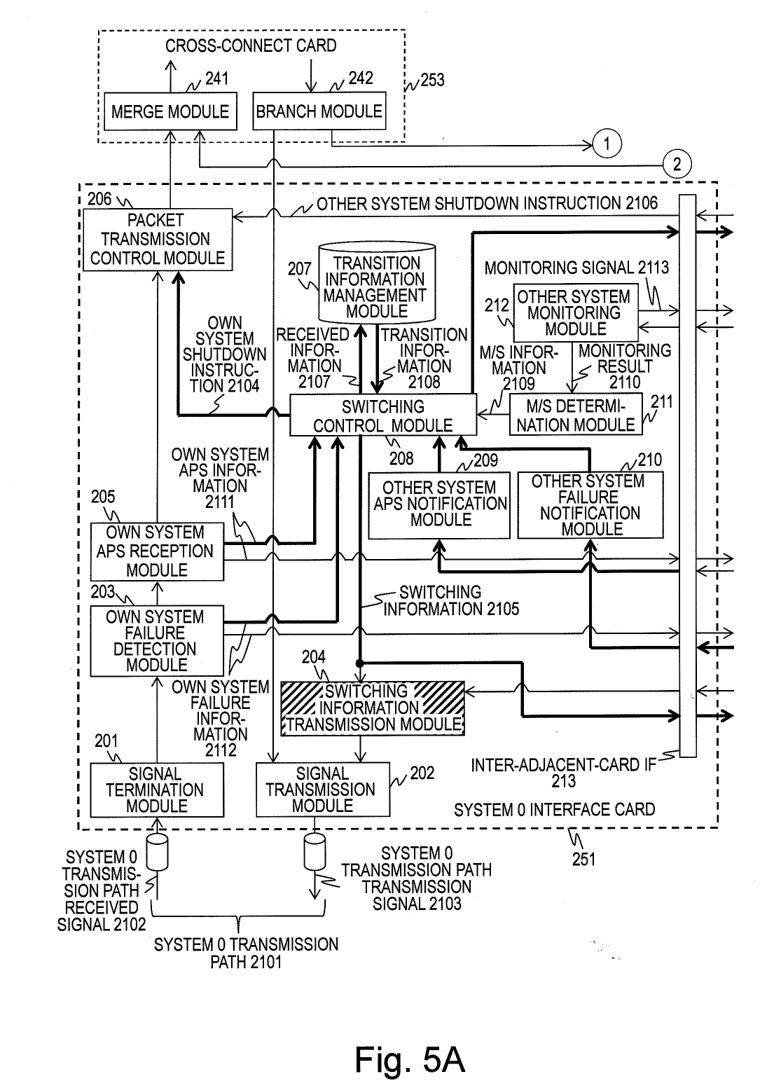

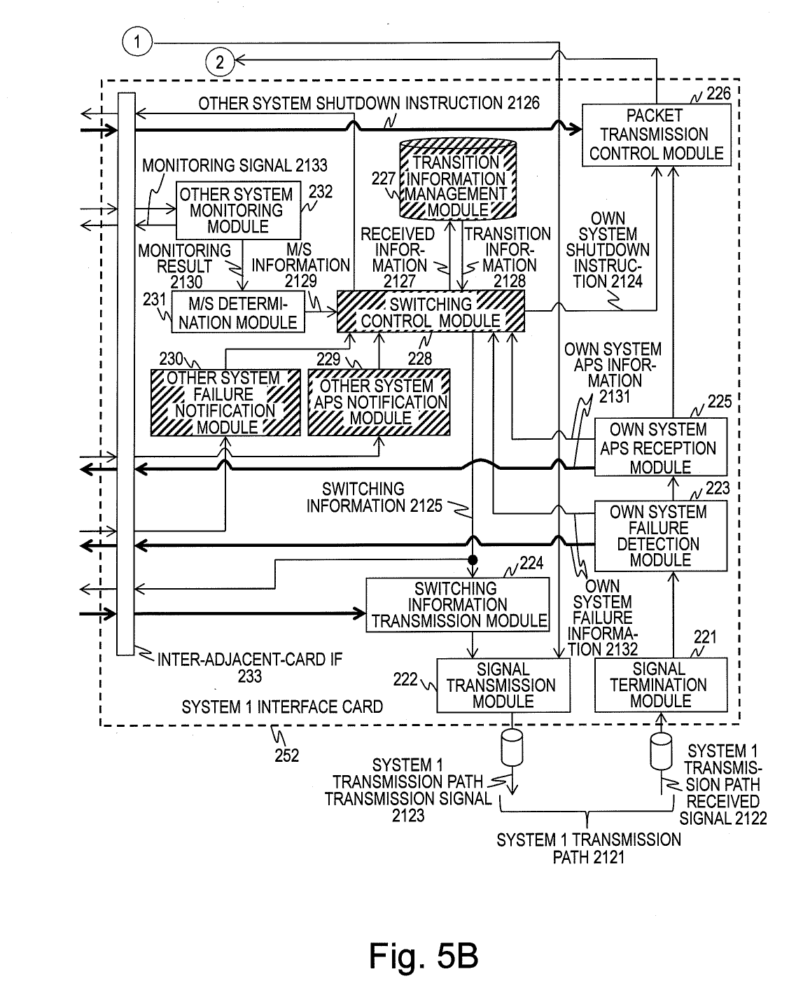

FIGS. 5A and 5B are explanatory diagrams illustrating the switching control of a line according to the embodiment of this invention. FIGS. 5A and 5B illustrate the switching control performed by the system 0 interface card 251 operating as the master.

In this case, it is assumed that the system 0 interface card 251 operates as the master and that the system 0 transmission path 2101 is a accommodated line. The switching control performed in a case where a state in which the transmission paths of the system 0 and the system 1 are both in a normal state is changed to a state in which a failure occurs in the system 0 transmission path is described below. It should be noted that in this embodiment, at the time of initial setting of the transmission device 200, the state 301 is set to “State 01”.

In the case where the system 0 interface card 251 operates as the master, the switching control module 228 and the transition information management module 227 of the system 1 interface card 252 operating as the slave are set to a stopped state.

Therefore, the switching control module 228 does not transmit the own system shutdown instruction 2124 to the packet transmission control module 226, and does not transmit the other system shutdown instruction 2106 to the packet transmission control module 206, either.

On the other hand, the switching control module 208 and the transition information management module 207 of the system 0 interface card 251 operating as the master are set to a state of being able to operate. Therefore, the switching control module 208 and the transition information management module 207 monitor a failure state and the APS information between the system 0 transmission path 2101 and the system 1 transmission path 2121, and perform the switching control.

The switching control module 208 always monitors a failure state of each of the system 0 transmission path received signal 2102 and the system 1 transmission path received signal 2122 which have been received, and the received APS information. Specifically, each of the constituent modules transmits a signal or information as follows.

The signal termination module 201 receives the system 0 transmission path received signal 2102, and executes termination processing on the received signal. Further, the signal termination module 201 transmits the system 0 transmission path received signal 2102 on which the termination processing has been executed to the own system failure detection module 203 and the own system APS reception module 205.

The own system failure detection module 203 monitors the failure state of the system 0 transmission path received signal 2102, and transmits to the switching control module 208 the own system failure information 2112 including a result of the monitoring. The own system APS reception module 205 monitors the received APS information of the system 0 transmission path received signal 2102, and transmits to the switching control module 208 the own system APS information 2111 including a result of the monitoring.

On the other hand, the signal termination module 221 receives the system 1 transmission path received signal 2122, and executes termination processing on the received signal. Further, the signal termination module 221 transmits the system 1 transmission path received signal 2122 on which the termination processing has been executed to the own system failure detection module 223 and the own system APS reception module 225.

The own system failure detection module 223 monitors the failure state of the system 1 transmission path received signal 2122, and transmits to the inter-adjacent-card IF 233 the own system failure information 2132 including a result of the monitoring. The own system failure information 2132 is transmitted to the switching control module 208 via the inter-adjacent-card IF 213 and the other system failure notification module 210.

Further, the own system APS reception module 225 monitors the received APS information of the system 1 transmission path received signal 2122, and transmits to the inter-adjacent-card IF 233 the own system APS information 2131 including a result of the monitoring. The own system APS information 2131 is transmitted to the switching control module 208 via the inter-adjacent-card IF 213 and the other system APS notification module 209.

In a case where a signal fail (SF) occurs in the system 0 transmission path 2101, the own system failure detection module 203 detects “system 0 SF”, and transmits to the switching control module 208 the own system failure information 2112 notifying of the detected “system 0 SF”.

On the other hand, the system 1 transmission path 2121 is normal, and hence the own system failure detection module 223 transmits to the switching control module 208, via the inter-adjacent-card IF 233, the inter-adjacent-card IF 213, and the other system failure notification module 210, the own system failure information 2132 notifying of “no failure in system 1”.

Further, the own system APS reception module 225 extracts the APS information from the system 1 transmission path received signal 2122. The own system APS reception module 225 transmits to the switching control module 208, via the inter-adjacent-card IF 233, the inter-adjacent-card IF 213, and the other system APS notification module 209, the own system APS information 2131 notifying of “received APS byte: no switching to select system 0”.

As used herein, the “APS information” refers to information indicating a switching state of the opposing device coupled via the system 0 transmission path 2101 or the system 1 transmission path 2121. Each of the interface cards and its corresponding device exchange the “APS information” with one another, and by confirming the arrival of the “APS information”, the switching control between the system 0 transmission path 2101 and the system 1 transmission path 2121 is performed between the interface card and the opposing device.

The switching control module 208 transmits to the transition information management module 207 the received information 2107 including information received from the respective constituent modules, and makes an inquiry about a transition destination in the switching state. In this case, the received information 2107 includes “System 0 SF” received from the own system failure detection module 203, “no failure in system 1” received from the other system failure notification module 210, and “received APS byte: no switching to select system 0” received from the other system APS notification module 209.

The transition information management module 207 refers to the transition table 300 based on the received information 2107 which has been received so as to determine the transition information, and transmits to the switching control module 208 the transition information 2108 including the “state”, “control”, and “APS” as a response.

Before the failure (SF) occurs in the system 0 transmission path 2101, the system 0 transmission path 2101 is selected and the transmission paths of both systems are normal, and hence the switching control module 208 remains in State 01 without making a transition of the state.

In a case where the failure occurs in the system 0 transmission path 2101 (occurrence of system 0 SF), such a state transition as indicated by a route 4001 of FIG. 4 is performed. Specifically, the transition information management module 207 determines the transition information, and transmits the corresponding transition information 2108 to the switching control module 208.

Specifically, in a case where the state 301 is “State 01” and the state transition occasion 302 is “occurrence of system 0 SF”, in the transition table 300, “state: 09, control: wait for RR response, APS: SFW” are defined as the transition information. Therefore, the system 0 interface card 251 makes a transition to State 09, transmits a code corresponding to “working signal fail (SFW)”, and makes a transition to a state of waiting for a response of RR from the opposing device.

Then, in State 09, in a case where the system 0 interface card 251 receives the response of RR from the opposing device, such a state transition as indicated by a route 4002 of FIG. 4 is performed. Specifically, the transition information management module 207 determines the transition information, and transmits the corresponding transition information 2108 to the switching control module 208.

Specifically, in a case where the state 301 is “State 09” and the state transition occasion 302 is “reception of RR”, in the transition table 300, “state: 10, control: switch to system 1, APS: SFW” are defined as the transition information. Therefore, the system 0 interface card 251 makes a transition to State 10, continues transmitting the code corresponding to the SFW, switches a transmission path (line) to the system 1 transmission path 2121, and waits for the next state transition occasion.

An example of a general APS switching has been described above, but there exist various standards for APS switching, and a switching protocol, a sequence, and a code for the APS value vary for each standard. Examples of the standards for APS switching include ITU-T G.841, ITU-T G.841 Annex B, ITU-T G.8031, and Telcordia GR-253-CORE.

As described above, the switching control module 208 receives from the transition information management module 207 the transition information 2108 including the “state”, “control”, and “APS”, performs the switching control based on the received transition information, and further, transmits the APS transmission value.

First, a method of transmitting the APS value is described.

The switching control module 208 extracts the APS transmission value included in the transition information 2108, and transmits to the switching information transmission module 204 the switching information 2105 including the extracted APS transmission value. The switching information 2105 is further transmitted to the signal transmission module 202.

The signal transmission module 202 multiplexes the main signal branched by the branch module 242 of the cross-connect card 253 and the switching information 2105 to generate the system 0 transmission path transmission signal 2103.

It should be noted that whether the APS transmission value is transmitted by using the system 0 transmission path transmission signal 2103 or the APS transmission value is transmitted by using the system 1 transmission path transmission signal 2123 differs for each standard.

For example, in a case where the APS transmission value is transmitted by using the system 1 transmission path transmission signal 2123, the switching control module 208 may transmit to the switching information transmission module 224, via the inter-adjacent-card IF 213 and the inter-adjacent-card IF 233, the switching information 2105 including the APS transmission value. Then, the signal transmission module 222 multiplexes the main signal branched by the branch module 242 of the cross-connect card 253 and the switching information 2105 to generate the system 1 transmission path transmission signal 2123.

Next, a method of switching the transmission path is described.

The switching of the transmission path refers to processing of selecting, by the cross-connect card 253, one of the system 0 transmission path received signal 2102 and the system 1 transmission path received signal 2122. It should be noted that the above-mentioned processing of this embodiment is different from a method of selecting a signal by the conventional selector 103.

Specifically, the packet transmission control module 206 and the packet transmission control module 226 stop transmission of a packet signal of one of the system 0 transmission path and the system 1 transmission path, of the packet signals to be transmitted from the own system APS reception module 205 and the own system APS reception module 225 to the cross-connect card 253, and a merge module 241 of the cross-connect card 253 merges the signal.

For example, in a case where the system 0 transmission path received signal 2102 is selected, the packet transmission control module 206 sets the packet signal to be transmitted to the merge module 241 of the cross-connect card 253 to “transmission”, and the packet transmission control module 226 sets the packet signal to be transmitted to the merge module 241 of the cross-connect card 253 to “stop”. As a result, only the system 0 transmission path received signal 2102 is transmitted from the merge module 241. Therefore, logically, a state in which the system 0 transmission path received signal 2102 is selected is obtained.

In a case where the configuration in which the transmission path is redundant is provided as in this embodiment, the selector 103 for selecting a signal is normally mounted on a card different from the system 0 interface card 251 and the system 1 interface card 252. On the other hand, in the case of the packet signal such as that in the MPLS-TP as described above, it is not necessary to directly control the selector 103, and the line switching control can be performed in the system 0 interface card 251 and the system 1 interface card 252.

As described above, in the route 4002 from State 09 to State 10, the transmission path is switched from the system 0 transmission path 2101 to the system 1 transmission path 2121. In this case, the switching control module 208 transmits the own system shutdown instruction 2104 to the packet transmission control module 206, to thereby stop the transmission of the system 0 transmission path received signal 2102. Meanwhile, the switching control module 208 transmits the other system shutdown instruction 2126 to the packet transmission control module 226, to thereby start the transmission of the system 1 transmission path received signal 2122. The system 1 transmission path received signal 2122 is transmitted to the merge module 241, and the system 1 transmission path received signal 2122 is transmitted from the merge module 241.

In this manner, the switching is performed as follows. One of the packet transmission control modules is controlled to be a stop (invalid) state, and the other of the packet transmission control modules is controlled to be a transmission (valid) state, and one of the system 0 transmission path received signal 2102 and the system 1 transmission path received signal 2122 is transmitted to the cross-connect card 253.

To summarize the above description, in the case where the system 0 interface card 251 operates as the master, a monitoring and control route regarding the switching control is a route indicated by the thick lines of FIGS. 5A and 5B. Specifically, the monitoring and control route is as follows.

First, the switching control module 208 monitors the own system APS reception module 205 and the own system failure detection module 203, and further, monitors the own system APS reception module 225 and the own system failure detection module 223 via the inter-adjacent-card IF 213 and the inter-adjacent-card IF 233. The switching control module 208 transmits to the transition information management module 207 the received information 2107 including information received from the respective constituent modules.

The transition information management module 207 refers to the transition table 300 based on the received information 2107 to determine the transition information (state, control, and APS), and transmits the corresponding transition information 2108 to the switching control module 208.

The switching control module 208 controls the packet transmission control module 206 and the packet transmission control module 226 based on the received transition information 2108. Further, the switching control module 208 transmits to the signal transmission module 222, via the inter-adjacent-card IF 213, the inter-adjacent-card IF 233, and the switching information transmission module 224, the switching information 2105 including the APS transmission value. In this manner, the system 1 transmission path transmission signal 2123 including the APS transmission value is transmitted.

In short, the switching control module 208 of the system 0 interface card 251 operating as the master monitors the system 0 interface card 251 and the system 1 interface card 252, and further, performs the switching control.

(2) Case where the system 1 interface card 252 operates as the master, and a failure occurs in the system 1 transmission path 2121 as a accommodated line.

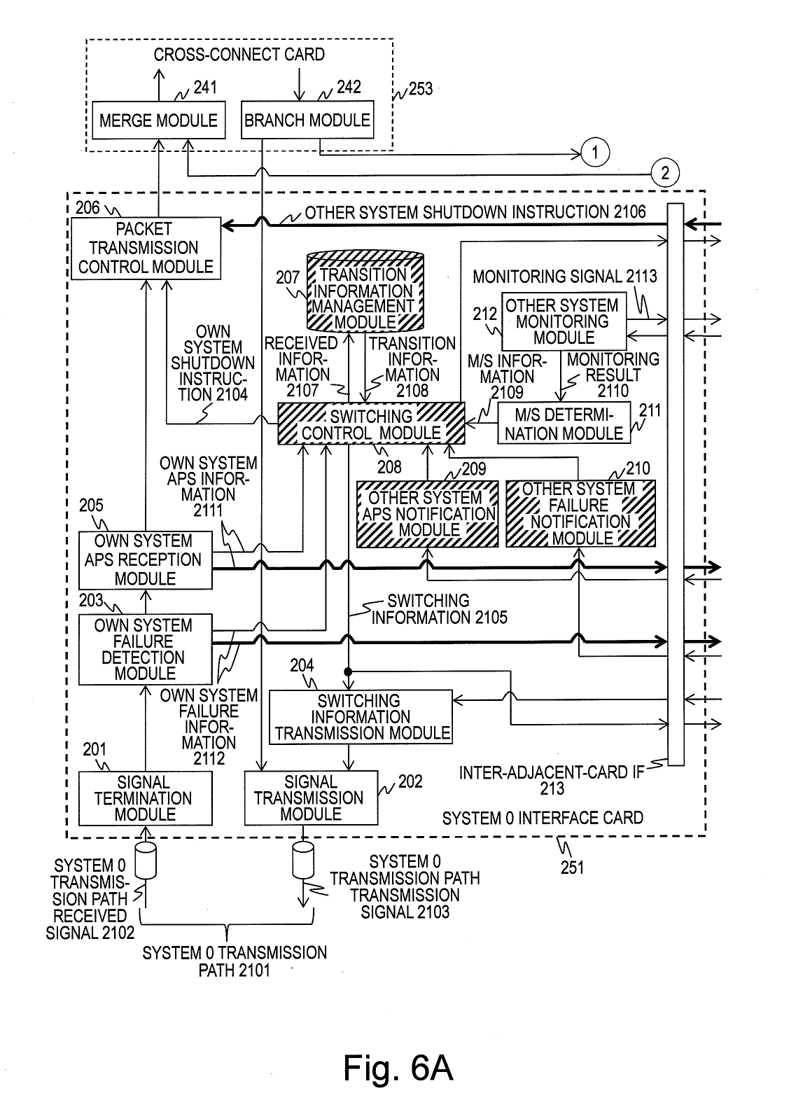

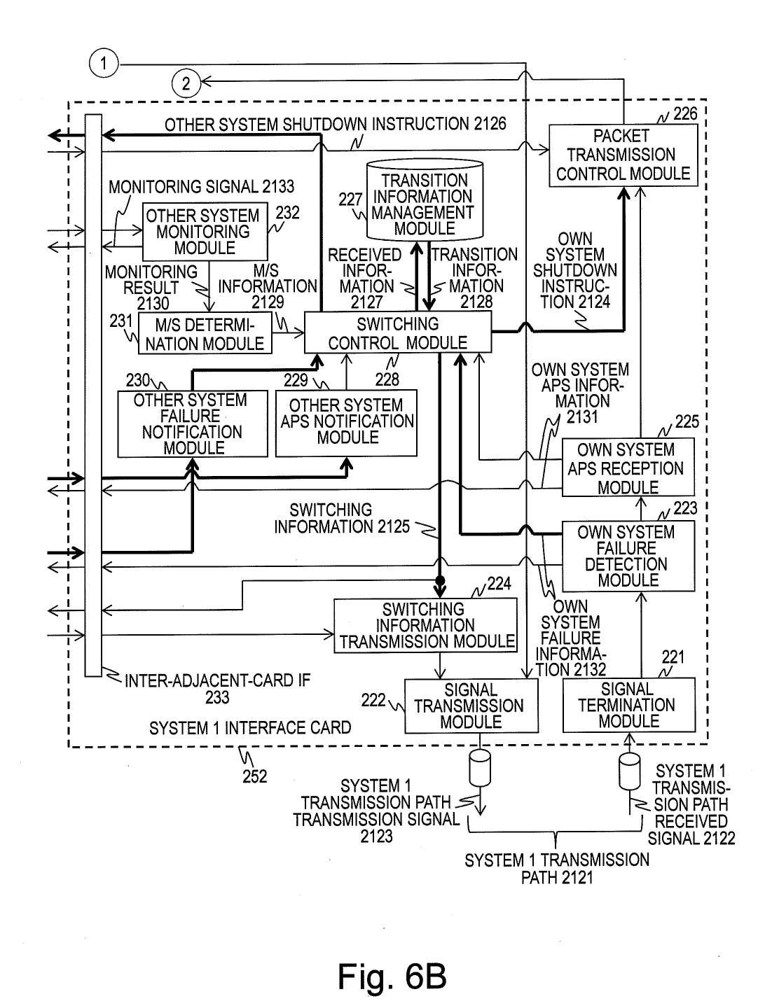

FIGS. 6A and 6B are explanatory diagrams illustrating the switching control of a line according to the embodiment of this invention. FIGS. 6A and 6B illustrate the switching control performed by the system 1 interface card 252 operating as the master.

In a case where the system 1 interface card 252 operates as the master, a monitoring and control route regarding the switching control is a route indicated by the thick lines of FIGS. 6A and 6B. Specifically, the monitoring and control route is as follows.

First, the switching control module 228 monitors the own system APS reception module 225 and the own system failure detection module 223, and further, monitors the own system APS reception module 205 and the own system failure detection module 203 via the inter-adjacent-card IF 233 and the inter-adjacent-card IF 213. The switching control module 228 transmits to the transition information management module 227 the received information 2127 including information received from the respective constituent modules.

The transition information management module 227 refers to the transition table 300 based on the received information 2127 to determine the transition information (state, control, and APS), and transmits corresponding transition information 2128 to the switching control module 228.

The switching control module 228 controls the packet transmission control module 206 and the packet transmission control module 226 based on the received transition information 2128. Further, the switching control module 228 transmits to the signal transmission module 222, via the switching information transmission module 224, the switching information 2125 including the APS transmission value. In this manner, the system 1 transmission path transmission signal 2123 including the APS transmission value is transmitted.

In short, the switching control module 228 of the system 1 interface card 252 operating as the master monitors the system 0 interface card 251 and the system 1 interface card 252, and further, performs the switching control.

According to this invention, based on the operating states of the switching control module 208 of the system 0 interface card 251 and the switching control module 228 of the system 1 interface card 252, it is determined whether each of the interface cards is to be the master or slave. It should be noted that the switching control between the master and slave is performed based only on the operating state of the switching control module 208 (or the switching control module 228), and the state of the line (transmission path) is not considered.

In other words, the switching control of the transmission path and the switching control between the master and slave are independently performed. Therefore, there may be a case where the system 0 interface card 251 operates as the master and the accommodated line is the system 1 transmission path 2121, or conversely, there may be a case where the system 1 interface card 252 operates as the master and the accommodated line is the system 0 transmission path 2101.

The switching control of the line to be accommodated (transmission path) and the switching control between the master and slave are independently performed for the following two reasons.

(Reason 1) For example, under the standard such as ITU-T G.841, ITU-T G.8031, and Telcordia GR-253-CORE, even in a case where the system 0 interface card 251 is not mounted on the transmission device 200, the system 0 transmission path 2101 may be selected as the line to be provisioned. Therefore, if the switching control between the master and slave is synchronized with the switching control of the provisioned line, there is a fear that an interface card that is not mounted may be selected as the master. In this case, the transmission device 200 becomes a deadlock state in which the monitoring of the failure state and the switching control cannot be performed.

(Reason 2) A recovery time of a service is desirably as early as possible, but if the master and slave are switched every time the line is switched, the recovery time of the service is delayed by the period of time required for the processing of switching between the master and slave.

In particular, (Reason 1) is a critical failure, and hence the switching control between the master and slave needs to be performed independently of the line switching control.

According to this invention, the other system monitoring module 212 of the system 0 interface card 251 and the other system monitoring module 232 of the system 1 interface card 252 check the operating states of the switching control module 208 and the switching control module 228 via the inter-adjacent-card IF 213 and the inter-adjacent-card IF 233, and transmit/receive a message to/from each other, to thereby switch between the master and slave. Specifically, the following processing is executed.

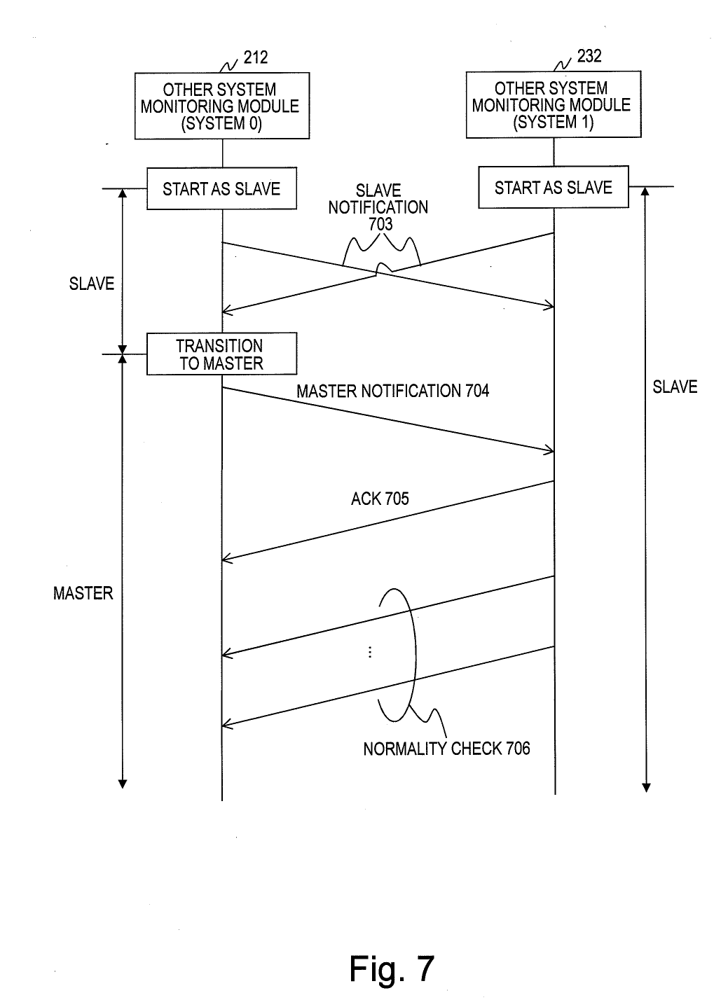

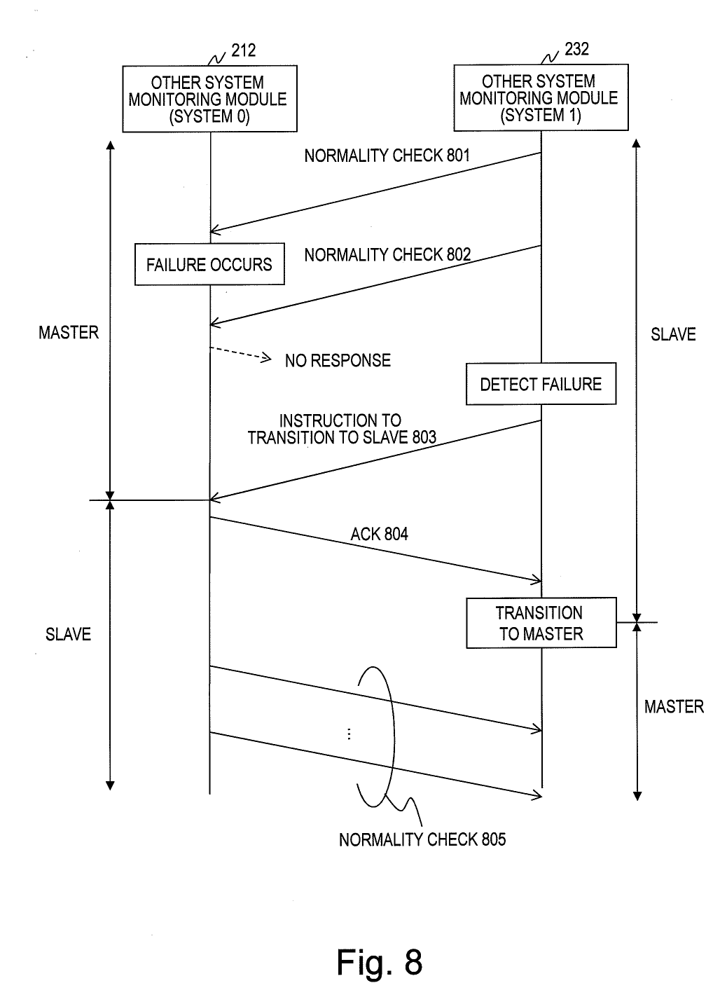

FIGS. 7 and 8 are sequence diagrams illustrating a flow of the processing of switching between the master and slave according to the embodiment of this invention.

In a case where the system 0 interface card 251 and the system 1 interface card 252 both start as a slave, the other system monitoring module 212 and the other system monitoring module 232 transmit slave notifications 703 notifying each other that the own interface card is the slave.

The other system monitoring module 212 which has received the slave notification 703 switches the own interface card to a master, and transmits to the other system monitoring module 232 a master notification 704 notifying the other system monitoring module 232 that the own interface card has become the master. It should be noted that an initial setting of the master may be made in advance, or may be instructed by an administrator of the transmission device 200. In this case, it is assumed that the initial setting is made in advance.

In a case of receiving the master notification 704, the other system monitoring module 232 transmits an ACK 705 as a response to the other system monitoring module 212, and thereafter, transmits a normality check 706 to the other system monitoring module 212 of the system 0 interface card 251 operating as the master. The other system monitoring module 232 determines, based on a response to the normality check 706, whether or not the operating state of the switching control module 208 of the system 0 interface card 251 is normal.

The other system monitoring module 232 transmits normality checks 801 and 802 to the other system monitoring module 212 to monitor the operating state of the switching control module 208 of the system 0 interface card 251 operating as the master.

In a case where a failure such as down occurs in the switching control module 208, there is no response to the normality check 802 from the other system monitoring module 212, and hence the other system monitoring module 232 detects the occurrence of the failure. Accordingly, the other system monitoring module 232 transmits an instruction to transition to slave 803 to the other system monitoring module 212.

In a case of receiving the instruction to transition to slave 803, the other system monitoring module 212 switches the own interface card to the slave, and transmits to the other system monitoring module 232 an ACK 804 as a response. In a case of receiving the ACK 804, the other system monitoring module 232 switches the own interface card to the master.

Thereafter, the other system monitoring module 212 switched to the slave transmits a normality check 805 to the other system monitoring module 232.

According to this invention, each of the interface cards includes the switching control module for performing the line switching control, and hence even in a case where an abnormality occurs in the switching control module of one of the interface cards, the line switching control can be performed. As a result, the separation of the control plane and the data plane is implemented.

Further, the switching control module is disposed for each of the interface cards in a distributed manner, and hence the switching control is performed on a card-by-card basis. Therefore, even in a case where the number of interface cards in the entire device and the number of accommodated lines increase, the line switching can be implemented without exceeding 50 ms, which is specified for the switching time of the legacy line such as the SDH. As a result, no restriction is imposed on the scalability of the number of accommodated lines and the number of interface cards.

Still further, the switching control module is disposed for each of the interface cards in a distributed manner, and hence the number of lines under the control of the switching control module can be made smaller. As a result, a period of time in which a service provisioned in the lines is disconnected is shortened as compared with a conventional case.

While the present invention has been described in detail and pictorially in the accompanying drawings, the present invention is not limited to such detail but covers various obvious modifications and equivalent arrangements, which fall within the purview of the appended claims.

What is claimed is:

1. A transmission device for receiving a user signal and transmitting to another device a transmission signal obtained by reflecting an APS transmission value on the received user signal, the transmission device comprising:
a plurality of interface units each capable of accommodating a communication line; and
a cross-connect unit for branching the user signal, which is transmitted from a client device, to be transmitted to each of the plurality of interface units, and coupling the communication line accommodated by each of the plurality of interface units to the client device,
wherein the transmission device is configured to provide redundancy to the communication line by using the plurality of interface units,
wherein the each of the plurality of interface units has a switching control module for performing switching control of an interface unit that accommodates a communication line for transmitting a main signal to the client device, and
wherein the switching control module is configured to:
select the interface unit for transmitting the main signal from among the plurality of interface units providing the redundancy; and
switch to any one of the plurality of interface units providing the redundancy to continue the transmission of the main signal in a case where a failure occurs in the selected interface unit.

2. The transmission device according to claim 1,
wherein the each of the plurality of interface units has a master determination module for determining the switching control module of an active system which controls the plurality of interface units, and
wherein the master determination module is configured to:
monitor the switching control module of the active system;
determine whether a failure occurs in the switching control module of the active system based on a result of the monitoring; and
determine a switching control module of a new active system from among the switching control modules of the plurality of interface units in a case where the failure occurs in the switching control module of the active system.

3. The transmission device according to claim 2,
wherein the each of the plurality of interface units has:
an APS obtain module for obtaining an APS received value in the communication line accommodated by the each of the plurality of interface units;
a failure detection module for detecting failure information indicating a failure in the communication line accommodated by the each of the plurality of interface units;
a transmission control module for controlling transmission of a signal to be transmitted to the client device via the communication line accommodated by the each of the plurality of interface units; and
a transmission module for setting the APS transmission value, and multiplexing the set APS transmission value and the user signal to generate the transmission signal, and
wherein the switching control module of the active system is configured to:
determine a control method for the each of the plurality of interface units and the APS transmission value based on the APS received value and the failure information;
transmit switching information including the determined APS transmission value to the transmission module; and
instruct the transmission control module of an interface unit for transmitting the main signal to permit signal transmission, and instruct the transmission control module of the each of the plurality of interface units other than the interface unit to stop the signal transmission based on the determined control method for the each of the plurality of interface units.

4. The transmission device according to claim 3, wherein the each of the plurality of interface units has hardware for implementing the switching control module, the master determination module, the APS obtain module, the failure detection module, the transmission control module, and the transmission module.

5. The transmission device according to claim 3, wherein the each of the plurality of interface units has:
a memory for storing programs for implementing the switching control module, the master determination module, the APS obtain module, the failure detection module, the transmission control module, and the transmission module; and
a processor for executing the programs stored in the memory.

6. The transmission device according to claim 3, wherein the switching control module uses a switching protocol in compliance with at least one of ITU-T G.841, ITU-T G.841 Annex B, ITU-T G.8031, and Telcordia GR-253-CORE.

7. An interface device included in a transmission device for receiving a user signal, which is transmitted from a client device, and for transmitting to another device a transmission signal obtained by reflecting an APS transmission value on the received user signal, the interface device being capable of accommodating a communication line,
wherein the transmission device uses at least two interface devices to provide redundancy to the communication line,
wherein the interface device comprises a switching control module for performing switching control of an interface device that accommodates a communication line for transmitting a main signal to the client device,
wherein the switching control module is configured to:
select an interface device for transmitting the main signal from among a plurality of the interface devices providing the redundancy; and
switch to any one of the plurality of the interface devices providing the redundancy to continue the transmission of the main signal, in a case where a failure occurs in the selected interface device.

8. The interface device according to claim 7, comprising a master determination module for determining the switching control module of an active system which controls the plurality of the interface devices included in the transmission device,
wherein the master determination module is configured to:
monitor the switching control module of the active system included in one of other interface devices, in a case where the switching control module of the interface device including the master determination module is not the switching control module of the active system;
determine whether a failure occurs in the switching control module of the active system based on a result of the monitoring; and
determine a switching control module of a new active system from among switching control modules included in the other interface devices, in a case where the failure occurs in the switching control module of the active system.

9. The interface device according to claim 8, comprising:
an APS obtain module for obtaining an APS received value in the communication line accommodated by the interface device and communication lines accommodated by the other interface devices;
a failure detection module for detecting failure information indicating a failure in the communication line accommodated by the interface device and the communication lines accommodated by the other interface devices;
a transmission control module for controlling transmission of a signal to be transmitted to the client device via the communication line accommodated by the interface device; and
a transmission module for setting the APS transmission value, and multiplexing the set APS transmission value and the user signal to generate the transmission signal,
wherein the switching control module is configured to, in a case of being the switching control module of the active system:
determine a control method for each of the plurality of the interface devices and the APS transmission value based on the APS received value and the failure information;
transmit switching information including the determined APS transmission value to the transmission module; and
instruct the interface device for transmitting the main signal to permit signal transmission, and instruct the other interface devices to stop the signal transmission, based on the determined control method for the each of the plurality of the interface devices.

10. The interface device according to claim 9, comprising hardware for implementing the switching control module, the master determination module, the APS obtain module, the failure detection module, the transmission control module, and the transmission module.

11. The interface device according to claim 9, comprising:
a memory for storing programs for implementing the switching control module, the master determination module, the APS obtain module, the failure detection module, the transmission control module, and the transmission module; and
a processor for executing the programs stored in the memory.

12. The interface device according to claim 9, wherein the switching control module uses a switching protocol in compliance with at least one of ITU-T G.841, ITU-T G.841 Annex B, ITU-T G.8031, and Telcordia GR-253-CORE.
